(19) United States
(12) Patent Application Publication
(10) Pub. No.: US 2010/0209822 A1
(43) Pub. Date: Aug. 19, 2010

(54) ULTRA-LIGHT BIPOLAR PLATE FOR FUEL CELL

(75) Inventors: Sejin KWON, Daejeon (KR); Jongkwang Lee, Daejeon (KR); Kiin Kim, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: KOREA ADVANCED INSTITUTE OF SCIENCE AND TECHNOLOGY, Daejeon (KR)

(21) Appl. No.: 12/417,923

(22) Filed: Apr. 3, 2009

(30) Foreign Application Priority Data
Feb. 17, 2009 (KR) 10-2009-0012911

(51) Int. Cl. H01M 8/04; H01M 2/02

(52) U.S. Cl. 429/523; 429/524; 429/532; 429/535

(57) ABSTRACT

Disclosed is a bipolar plate for a fuel cell, including: a non-conductive anode membrane on which a fuel flow channel is formed; a non-conductive cathode membrane on which an air flow channel is formed; a non-conductive separation membrane that is provided between the anode membrane and the cathode membrane to separate them from each other so that the fuel and the air are not mixed; and a metal unit that provides a current moving path allowing charge to be moved from the anode membrane to the cathode membrane via the separation membrane when the anode membrane, the separation membrane and the cathode membrane are stacked sequentially. More specifically, each of the anode membrane, the cathode membrane and the separation membrane is glass, preferably, photosensitive glass.

### TECHNICAL FIELD

The present invention relates to a fuel cell, and more particularly, to a bipolar plate for a polymer electrolyte membrane fuel cell in which the bipolar plate includes photosensitive glass and metal, has very excellent processability, has high strength, thermal conductivity and electrical conductivity, has low gas permeability, and is ultra-light.

### BACKGROUND ART

With the industrial development and increase in population, energy demand has been rapidly increased around the world, however, the production of petroleum/natural gas, etc., main energy resource, is expected to be gradually decreased, turning around by about 2020. With the exhaustion of fossil fuel, there has been an urgent demand for research and development for clean alternative energy that does not pollute the environment.

Also, the Kyoto protocol aiming at reducing greenhouse gas has been adopted in 1997 and then has been ratified by 119 countries including Korea so that the mandatory reduction in the greenhouse gas emissions and the burden of the mandatory greenhouse gas reduction have been progressed.

Techniques using diverse natural resources such as solar energy, wind power, and hydrogen energy, etc., have been researched and developed, however, the technique of a fuel cell has been spotlighted as an alternative clean energy in that it is the environment-friendly alternative sources of energy that has a high power generation efficiency using a direct power generation method that does not need a combustion process or a mechanical task differently from the conventional thermal power generation, not affected by thermodynamic restriction (Carnot efficiency), reduces emission of CO₂, not emitting NOx and Sox, etc., that are air pollution materials, and has very negligible operation noise/vibration, and in that a dispersive power production method is possible and the power capacity can be easily controlled, such as a large and medium-sized power generation system field of 100 kW to several tens kW, a small-sized residential power generation system and an automobile auxiliary power resource of 1 kW to 10 kW, and a mobile power source of several W to several kW, etc.

The fuel cell, which is a device that converts chemical energy into electrical energy by reacting fuel gas such as hydrogen H₂ to oxygen O2₂, generally includes an anode (fuel electrode) and a cathode (fuel electrode).

In the anode, a hydrogen cation and an electron are generated by a catalyst reaction, wherein the generated hydrogen cation is moved to the cathode via electrolyte and the electron is moved to the cathode from the anode along an external circuit. Also, in the cathode, the hydrogen cation moved via the electrolyte is reacted with the electron moved along the external circuit so that water is generated. At this time, a fixed potential difference is generated between the anode and the cathode.

Such a fuel cell can be classified into various kinds according to kinds of electrolyte to be used and operational temperature. In particular, a polymer electrolyte membrane fuel cell (PEMFC) that is operated at a relatively low temperature below 100° C. and directly uses hydrogen as fuel has been spotlighted as a power source for an automobile, a residential power generation and a transportation.

The polymer electrolyte membrane fuel cell has a stack structure configured of a plurality of unit cells in order to generate an output to be required, wherein the unit cell includes a membrane electrode assembly (MEA) and a bipolar plate, the membrane electrode assembly (MEA) being configured to include a polymer electrolyte membrane where the hydrogen cation can be moved, a catalyst electrode that causes oxidation and reduction reaction of the fuel and air, and a gas diffusion layer that supplies the fuel and air uniformly to the catalyst electrode and the bipolar plate having predetermined flow paths that are disposed on both sides of the membrane electrode assembly to supply the fuel and the air to the both sides.

As described above, the polymer electrolyte membrane fuel cell has a stack structure where the membrane-electrode assembly and the bipolar plate are repeatedly stacked to be connected to each other in series or in parallel in order to control the output of energy and the capacity. Such a stack structure has a structure where the membrane-electrode assembly and the bipolar plate are repeatedly stacked, plates of metal or plastic material are installed on both ends thereof, and a bolt and a nut are engaged with the plates to be compressed by a predetermined pressure, thereby being closely adhered.

The bipolar plate provided in the polymer electrolyte membrane fuel cell is an important component that uniformly distributes the fuel such as hydrogen and air (oxygen) in a reaction region of the fuel cell stack and transfers electricity between the unit cells. Therefore, the bipolar plate requires high electrical conductivity and thermal conductivity, an appropriate mechanical strength, corrosion resistance and thermal stability, etc.

However, commonly, the weight percent occupied by the bipolar plate within the entire fuel cell stack is more than 80% and the thickness percent occupied thereby is more than 85% so that it is necessary to reduce the mass and volume of the bipolar plate in order to make the fuel cell small and light.

As the bipolar plate, metal material, graphite or composite mixed with polymer resin is commonly used.

In the case of the graphite (carbon-based) bipolar plate that is most commonly used, the thermal conductivity, the electrical conductivity and the corrosion resistance are excellent, but the mechanical strength is weak. Although the graphite bipolar plate has a low material density appropriate for lightening, it has bad mechanical strength and processability and further has a high permeability of fluid so that it has to be manufactured to have a thick thickness of several mm or more and has a fluid flow channel having a limited size.

In the case of the metal-based bipolar plate that is commonly used following the graphite, the electrical conductivity, the thermal conductivity and the mechanical strength are excellent and it is free from a gas permeability, but has problems in that the chemical stability is low and electric resistance is raised due to a surface oxidation film. Also, in view of miniaturization and lightening, the high density of metal indispensably increases the mass of the cell of the fuel cell.

In the case of the composite material-based bipolar plate, the corrosion resistance is more excellent than metal but there is a problem in that it is difficult to implement the properties of the electrical conductivity and the thermal conductivity simultaneously with the properties of the processability and the mechanical strength.

### DISCLOSURE OF THE INVENTION

It is an object of the present invention to provide a bipolar plate that satisfies strength, thermal conductivity, electrical conductivity, chemical stability, and gas permeability and remarkably reduces mass and volume, and is to provide a bipolar plate that is manufactured through a low unit price and a simple process to have an ultra fine processability.

To achieve the object of the present invention, the present invention provides a bipolar plate for a fuel cell, including: a non-conductive anode membrane on which a fuel flow channel is formed; a non-conductive cathode membrane on which an air flow channel is formed; a non-conductive separation membrane that is provided between the anode membrane and the cathode membrane to separate them from each other so that the fuel and the air are not mixed; and a metal unit that provides a current moving path allowing charge to be moved from the anode membrane to the cathode membrane via the separation membrane when the anode membrane, the separation membrane and the cathode membrane are stacked sequentially.

At this time, preferably, the fuel cell is a polymer electrolyte membrane fuel cell.

The anode membrane, the cathode membrane, and the separation membrane are constituted by non-conductive material that satisfies strength, thermal conductivity, chemical stability, gas permeability, processability, bonding property, and lightweight property that are required for the bipolar plate of the fuel cell. The metal unit provides the intermembrane current moving path (anode membrane, separation membrane, and the cathode membrane) constituted by such non-conductive material.

In order to provide the bipolar plate characterized in that strength, thermal conductivity and chemical stability are high, gas permeability is low, processability is very excellent, intermembrane (anode membrane, separation membrane and cathode membrane) bonding is easy, and it is ultra-light, each of the anode membrane, the cathode membrane and the separation membrane is glass, preferably, photosensitive glass, more preferably, photosensitive crystallization glass.

In order to obtain more excellent processability including the ultra-fine processing, each of the anode membrane, the cathode membrane and the separation membrane is photosensitive glass that is photosensitized by ultraviolet rays.

The metal unit that provides the intermembrane current moving path when the anode membrane, the cathode membrane and the separation membrane are stacked sequentially is at least one conductive metal rod that penetrates through the anode membrane, the cathode membrane and the separation membrane.

At this time, preferably, the metal rod penetrates through edge region of the anode membrane, the cathode membrane and the separation membrane, that is, the region on which the channel is not formed. Preferably, the number of the provided metal rode is determined according to the shape of the anode membrane, the cathode membrane and the separation membrane. For example, if the anode membrane, the cathode membrane and the separation membrane overall has a rectangular shape, preferably four metal rods are provided in order to penetrate through each of four edge region of the rectangular.

The metal unit that provides the intermembrane current moving path when the anode membrane, the cathode membrane and the separation membrane are stacked sequentially is metal deposition layers that are deposited on the respective surfaces of the anode membrane, the cathode membrane and the separation membrane.

The bipolar plate includes a basic unit where the anode membrane, the cathode membrane and the separation membrane are stacked sequentially and thermally coupled (eq. thermally bonded), and the metal unit, preferably, the metal rod. Preferably, the bipolar plate further includes a metal deposition layer provided on the surface of the basic unit. Preferably, the metal unit includes the metal rod and the metal deposition layer provided on the surface of the basic unit.

The metal deposition layers provided on the upper and lower surfaces of the basic unit effectively collect electrons generated from a membrane electrode assembly (MEA) that constitutes the fuel cell to allow them to move among the membranes (anode membrane, separation membrane and cathode membrane) via the metal rod.

In view of electrical conductivity, manufacturing costs, easiness in deposition and molding, chemical stability, interfacial bonding property with glass, and low metal density, preferably, the metal of the metal rod or the metal deposition layer is at least one selected from the group consisting of silver, gold, platinum, nickel, chrome, titanium and aluminum.

The channel of the anode membrane and the cathode membrane is formed by removing a region on which light is selectively exposed by a mask pattern from a photosensitive glass plate that is raw material of the anode membrane or the cathode membrane.

More specifically, the channel is formed by recrystallizing the region on which the light is exposed through annealing and then etching the recrystallized region, alternatively, by directly etching the region on which the light is exposed. The etching is a wet-etching that is performed using etching solution including HydroFluoric acid (HF).

The light emitted in order to form the channel is ultraviolet rays, and the photosensitive glass plate is UV (ultraviolet rays)-sensitive glass.

The channel is a channel that is penetrated in the thickness direction of the photosensitive glass plate that is the raw material.

The separation membrane is provided with a cooling fluid channel and, more specifically, includes a upper separation membrane that seals one side of the fuel flow channel provided on the anode membrane; a cooling channel membrane formed with barrier ribs of the cooling fluid channel; and a lower separation membrane that seals one side of the air flow channel provided on the cathode membrane, wherein preferably, the upper separation membrane, the cooling channel membrane, and the lower separation membrane are sequentially stacked to be thermally coupled.

The upper separation membrane physically separates the fuel flow channel from the cooling fluid channel, and the lower separation membrane physically separates the air flow channel from the cooling fluid channel.

The bipolar plate of the present invention can reduce mass and volume remarkably, satisfying strength, thermal conductivity, electrical conductivity, chemical stability, and gas permeability required for the fuel cell, can have channels having a ultra-fine structure and a high complexity through a simple process, and can implement a ultra-compact/ultra-light fuel cell.

### BRIEF DESCRIPTION OF THE DRAWINGS

FIG. 1 is an exploded perspective view of a bipolar plate in accordance with an embodiment of the present invention.

FIG. 2 is a perspective view of the bipolar plate in accordance with the embodiment of the present invention.

FIG. 3 is an example of a fuel cell stack in which the bipolar plate in accordance with the embodiment of the present invention is provided.

FIG. 4 is a process view showing a manufacturing process of an anode membrane, a cathode membrane, and a separation membrane provided in the bipolar plate in accordance with the embodiment of the present invention.

FIG. 5 is a cross-sectional view showing structures of the anode membrane, the cathode membrane, and the separation membrane provided in the bipolar plate in accordance with the embodiment of the present invention.

FIG. 6 is a cross-sectional view of a basic unit in accordance with an embodiment of the present invention.

FIG. 7 is a cross-sectional view of the bipolar plate in accordance with an embodiment of the present invention.

FIG. 8 is a cross-sectional view showing structures of the anode membrane, the cathode membrane, and the separation membrane, with a metal deposition layer, provided in the bipolar plate in accordance with the embodiment of the present invention.

FIG. 9 is another example of a cross-sectional view of the bipolar plate in accordance with the embodiment of the present invention.

FIG. 10 is a cross-sectional view of a basic unit in which the metal deposition layer in accordance with the embodiment of the present invention is provided.

FIG. 11 is still another example of a cross-sectional view of the bipolar plate in accordance with the embodiment of the present invention.

FIG. 12 is an optical photograph of one basic unit in accordance with the embodiment of the present invention.

FIG. 13 is another example of the separation membrane in accordance with the embodiment of the present invention.

### DETAILED DESCRIPTION OF MAIN ELEMENTS

10: CATHODE MEMBRANE
20: SEPARATION MEMBRANE
30: ANODE MEMBRANE
60: METAL ROD
70, 80: METAL DEPOSITION LAYERS
12: AIR FLOW CHANNEL
32: FUEL FLOW CHANNEL
11, 21, 31: PHOTOSENSITIVE GLASSES
25: COOLING FLUID CHANNEL

### BEST MODE FOR CARRYING OUT THE INVENTION

Hereinafter, a bipolar plate of the present invention will be described in detail with reference to accompanying drawings. In the following detailed description, only certain preferred embodiments of the present invention have been shown and described, simply by way of illustration. As those skilled in the art would realize, the described embodiments may be modified in various different ways, all without departing from the spirit or scope of the present invention. Also, like reference numerals designate like elements throughout the specification.

At this time, if there are no other definitions for technical terms and scientific terms, they have meanings that are commonly understood by those skilled in the art. If it is judged that the specific explanation on the related well-known constitution or function may make the gist of the present invention obscure, the detailed explanation thereof will be omitted.

In the explanation hereinafter, as the non-conductive material that constitutes a non-conductive cathode membrane, a non-conductive separation membrane, and a non-conductive anode membrane, non-conductive material that only satisfies the physical characteristics required for a bipolar plate for fuel cell such as chemical reactivity, strength, easiness in processing, low-density, gas permeability, and bonding property, without considering electrical conductivity, is used according to the characteristics of the present invention. According to such characteristics of the present invention, a metal unit that is another characteristic of the present invention is provided so that finally, the present invention has a characteristic structure where the electrical conductivity required for the bipolar plate is also satisfied.

In view of the chemical reactivity, the strength, the easiness in processing, the low-density, the gas permeability, and the bonding property, the non-conductive material that constitutes the non-conductive cathode membrane, the non-conductive separation membrane, and the non-conductive anode membrane of the present invention is glass, more specifically, soda-lime glass, potassium-lime glass, lead glass, barium glass, silica glass, boro-silicate glass or phosphate glass.

In view of the ultra-fine structure patterning and the easiness in processing, the present invention has another characteristic structure that the non-conductive material that constitutes the non-conductive cathode membrane, the non-conductive separation membrane, and the non-conductive anode membrane of the present invention is photosensitive glass. Therefore, the processability and the processing resultant of the bipolar plate in the present invention may obtain the performance and effect similar to those of the photolithography of a semiconductor.

In order to more clarify the characteristic constitution of the present invention with reference to accompanying drawings, a case where photosensitive glass is material that constitutes a cathode membrane, a separation membrane, and an anode membrane will be described.

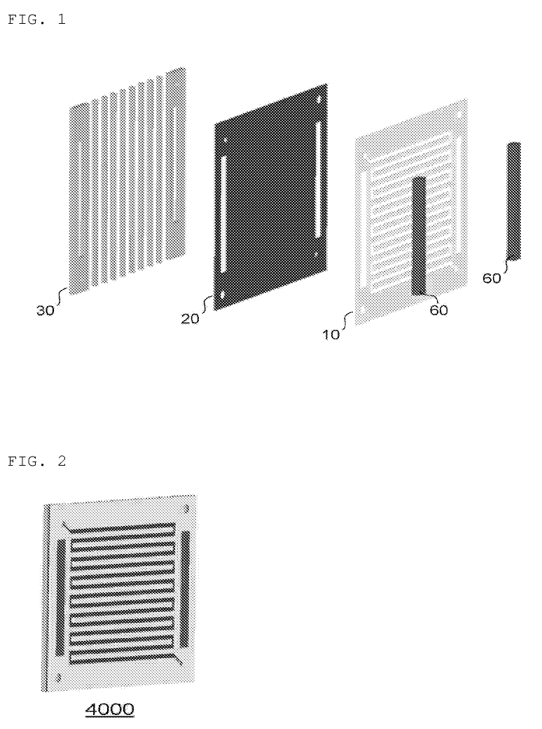

FIG. 1 is an exploded perspective view of a bipolar plate for a fuel cell in accordance with an embodiment of the present invention. Referring to FIG. 1, the bipolar plate for the fuel cell of the present invention includes a non-conductive anode membrane 30 on which a flow channel of fuel including hydrogen is formed, a non-conductive cathode membrane 10 on which a flow channel of air including oxygen is formed, a non-conductive separation membrane 20 provided between the anode membrane 30 and the cathode membrane 10, and a metal unit 60 that forms an intermembrane current moving path between the separation membrane 20 and the anode membrane 30.

FIG. 1 shows an example where the metal unit 60 is a metal rod 60 penetrating through the cathode membrane 10, the separation membrane 20, and the anode membrane 30. As shown in FIG. 1, the metal rod 60 preferably penetrates through the cathode membrane 10, the separation membrane 20 and the anode membrane 30 so that it does not affect the channel formed on the cathode membrane 10 or the anode membrane 30.

The metal rod 60 has characteristics of high electrical conductivity, chemical stability, easiness in processing, suppression in forming an oxidation film. The metal rod 60 is preferably formed of at least one selected from the group consisting of silver, gold, platinum, nickel, chrome, titanium and aluminum that have low material density similar to graphite.

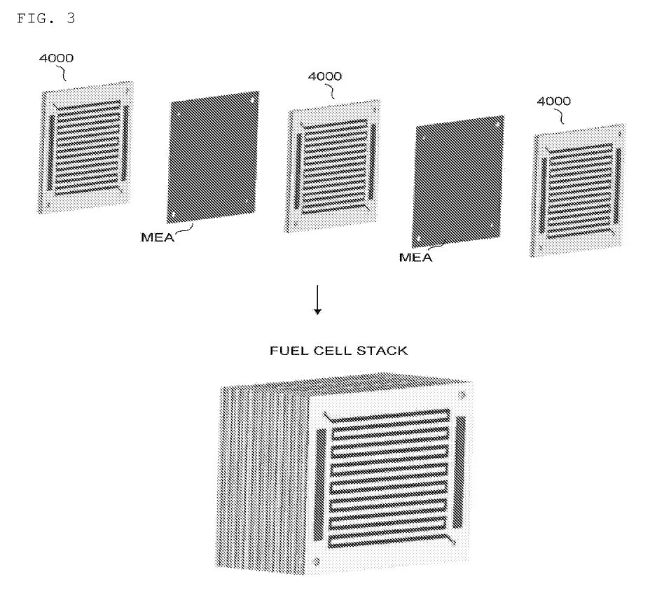

FIG. 2 is a perspective view of the bipolar plate 4000 in accordance with the embodiment of the present invention, in which the cathode membrane 10, the separation membrane 20, and the anode membrane 30 are sequentially stacked and the metal rod 60 penetrating among the membranes is provided.

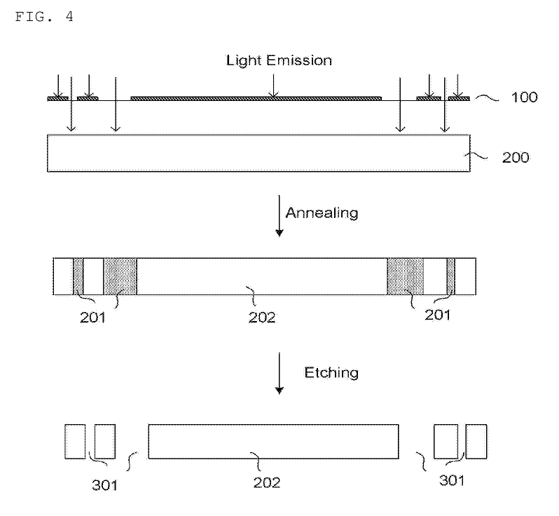

The bipolar plate according to the present invention is alternately coupled to a membrane electrode assembly (MEA) (MEA in FIG. 3) to form a fuel cell stack (fuel cell stack in FIG. 3).

The cathode membrane 10, the separation membrane 20, and the anode membrane 30 constituted by the non-conductive material is formed of glass, preferably, photosensitive glass, more preferably, photosensitive crystallization glass.

The photosensitive glass that is the preferred non-conductive material of the present invention is glass that contains a photosensitive metal element in an ion state and whose material characteristics or crystal characteristics are varied by emission of light (including annealing performed after the emission of light). The photosensitive metal element may be at least one selected from the group consisting of Cu, Ag, Au, Se, Cd, Cs, V, Cr, Mn, Fe, Ni, Co, Ti, Ce, Mo, W and U. The photosensitive glass may be soda-lime glass, potassium-lime glass, lead glass, barium glass, silica glass, boro-silicate glass or phosphate glass, based on the main material that constitutes glass, for example, common photosensitive glass that further contains at least one addition selected from the group consisting of LiO₂, Li₂O₃, K₂O, Al₂O₃, Na₂O, ZnO, Sb₂O₃, Ag₂O and CeO₂, having SiO₂ as the main material.

Characteristically, the photosensitive glass is glass having ultraviolet photosensitivity. The photosensitive glass preferably is photosensitive glass for chemical cutting processing including photosensitive obsered glass and photosensitive crystallization glass.

The photosensitive glass that constitutes the cathode membrane 10, the separation membrane 20 and the anode membrane 30 has remarkably lower gas permeability compared to graphite, making it possible to prevent the mixture and leakage of gases by itself. Also, the photosensitive glass can form a very fine and complicated channel through the light emission and etching similar to the lithography of the semiconductor. The photosensitive glass is characterized in that the strength of glass itself is remarkably excellent compared to that of graphite, the thickness of the channel, the cathode membrane 10, the separation membrane 20, and the anode membrane 30 can be optionally controlled, it is very stable in the operating temperature range of the polymer electrolyte membrane fuel cell thermally and chemically, and it has very low material density similar to graphite.

Based on the characteristics of the bipolar plate of the present invention as described above, ultra-light and ultra-compact fuel cell can be implemented and the power density of the fuel cell stack can be improved.

Although the glass, preferably, the photosensitive glass is excellent material that satisfies physical/chemical characteristics required for the bipolar plate for the fuel cell, it is insulating material that has remarkably low electrical conductivity compared to graphite. In order to solve such an electrical conductivity, the present invention has the metal unit that forms the intermembrane current moving path.

The comparison of mass, volume and electrical conductivity between graphite that is used as a common bipolar plate and the bipolar plate of the present invention will be represented by following table 1.

TABLE 1

| | | | Electrical |
|---|---|---|---|
| | Mass | Volume (mm) | conductivity |
| | (g) | (w × h × t) | (Ω × m)⁻¹ |
| Graphite | 24 | 57 × 60 × 4.5 | 3 × 10⁴~2 × 10⁵ |
| Photosensitive | 4.7 | 44 × 44 × 1.6 | 3.8 × 10⁷ (Al) |
| Glass | | | |

By the photosensitive glass, preferably, the photosensitive glass that is photosensitized by ultraviolet rays, that is the characteristic constitution of the present invention, as shown in FIG. 4, a highly completed shaped fine structure including a ultra-fine channel may be provided on the cathode membrane 10, the separation membrane 20 or the anode membrane 30 through a simple process similar to the lithography of the semiconductor.

More specifically, as shown in FIG. 4, a mask 100 having a pattern to be processed is positioned on the photosensitive glass plate 200 that is raw material of the cathode membrane 10, the separation membrane 20 or the anode membrane 30, and then light is emitted on the photosensitive glass plate 200 selectively according to the pattern. Thereafter, annealing is performed so that the region on which the light is emitted is recrystallized 201 and the region recrystallized by performing a wet-etching is selectively removed, making it possible to form a fine structure 301 that includes a channel on the glass plate 200.

Thereby, the cathode membrane 10, the separation membrane 20 or the anode membrane 30 is formed of glass having the fine structure including the channel and region on which the light is not emitted.

The light is preferably ultraviolet rays with which the ultra-fine processing can be performed. Although the thickness of the glass plate is to be determined considering the output and usage of the fuel cell stack to be manufactured, the thickness is preferably between 0.1 mm and 2 mm by way of the substantial example of the ultra-light bipolar plate. Although the annealing temperature is to be controlled properly according to the photosensitive glass material, the annealing may be performed at temperature from 500° C. to 600° C. by way of the substantial example.

FIG. 4 shows an example where the fine structure penetrating through the thickness of the glass plate. However, a fine structure where the glass plate has a surface roughness (roughness by engraving) by allowing the glass plate to be etched to a predetermined thickness by controlling an etching time, etc. may also be formed.

Also, in FIG. 4, when the selective etching characteristics (such a recrystallization) by the light emission is provided as in the photosensitive recrystallization glass, the region on which the light is emitted may be removed by directly performing the wet-etching, not performing the annealing.

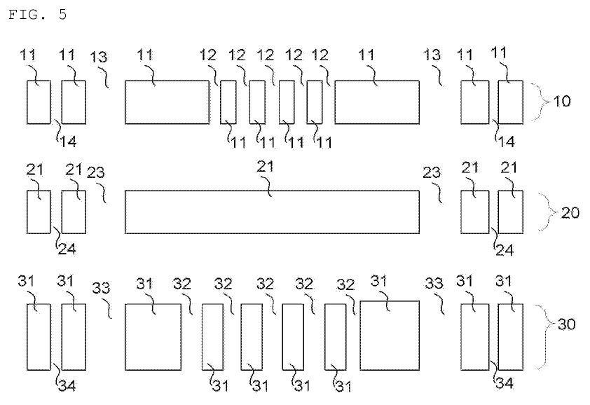

FIG. 5 is a cross-sectional view showing structures of the cathode membrane 10, the separation membrane 20, and the anode membrane 30 of the present invention, manufactured by the light emission and etching of FIG. 4.

The cathode membrane 10 of the present invention includes a air flow channel 12 that penetrates in a thickness direction, a penetration pore 13 where a metal rod is provided, a photosensitive glass 11, and a coupling pore 14 that provides a path of a coupling member (for example, a bolt and a nut) that couples a membrane electrode assembly (MEA) (MEA in FIG. 3) to the bipolar plate of the present invention.

The coupling member provided in the coupling pore 14 couples and fixes factors that constitute a unit cell simultaneously with coupling and fixing a plurality of unit cells.

The anode membrane 30 of the present invention includes a fuel flow channel 32 that is penetrated in a thickness direction, a penetration pore 33 that is formed on a position corresponding to the penetration pore 13 of the cathode membrane 10 to be provided with the same metal rod, a photosensitive glass 31, and a coupling pore 33 that is formed on a position corresponding to the coupling pore 13 of the cathode membrane 10 to provide a path of the coupling member.

The separation membrane 20 of the present invention includes a penetration pore 23 that is formed on a position corresponding to the penetration pore 13 of the cathode membrane 10 to be provided with the same metal rod, a coupling pore 23 that is formed on a position corresponding to the coupling pre 13 of the cathode membrane 10, and a photosensitive glass 21, wherein the air flow path 12 of the cathode membrane 10 is physically separated from the fuel flow path 32 of the anode membrane 30 by the photosensitive glass 21.

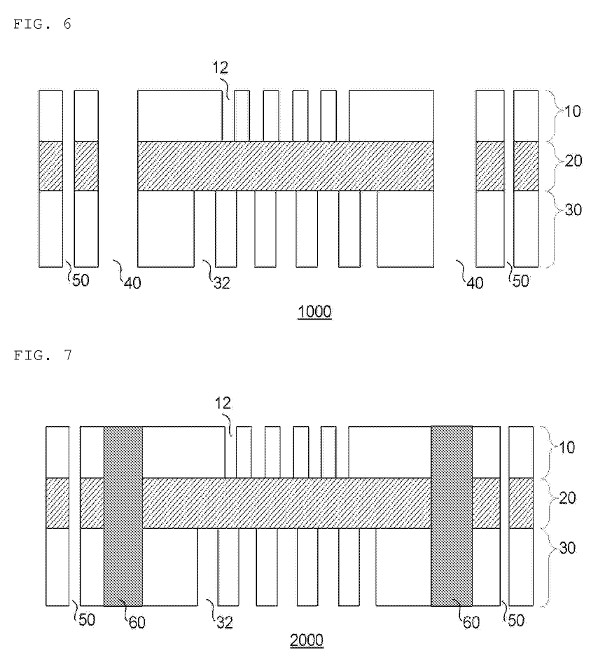

The cathode membrane 10, the separation membrane 20 and the anode membrane 30 manufactured by the light emission and etching of FIG. 4 to have the structure of FIG. 5 are stacked sequentially so that the respective membranes 10, 20 and 30 are thermally coupled by performing the annealing, thereby preferably forming a basic unit 1000 of FIG. 6.

The thermal coupling of the cathode membrane 10, the separation membrane 20 and the anode membrane 30 that are stacked sequentially is preferably a junction by the annealing performed at temperature higher than a glass transition temperature (a glass transition temperature of the photosensitive glasses 11, 21 and 31). It may be a thermal coupling through the annealing performed at temperature higher than 500° C. by way of the substantial example.

Therefore, the basic unit 1000 includes photosensitive glasses of the cathode membrane 10, the separation membrane 20 and the anode membrane 30, the fuel flow channel 32 and the air flow channel 12 physically separated by the separation membrane 20, a penetration pore 40 where the penetration pores 23 of the cathode membrane 10, the separation membrane 20 and the anode membrane 30 are coupled to be provided with a single metal rod, and a coupling pore 50 where the coupling pores 23 of the cathode membrane 10, the separation membrane 20 and the anode membrane 30 are coupled to be provided with a single coupling member.

Referring to FIG. 7, the bipolar plate 2000 of the present invention includes the basic unit 1000 and a metal rod 60 that is provided in the penetration pore 40, wherein the metal rod provides the intermembrane current moving path of the cathode membrane 10, the separation membrane 20, and the anode membrane 30 and the intercell current moving path of the fuel cell that constitutes the stack, and provides an electrical connection with an external circuit.

The shortest cross-section of the metal rod 60 is to be determined considering of the output of the fuel cell stack to be manufacture, the dimension of the fuel cell unit cell to be manufactured, and the usage of the fuel cell. However, in view of the reduction in volume of the bipolar plate and the providing of the stable current moving path thereof, the metal rod 60 preferably has a cross-section of 100 μm² to 5000 mm².

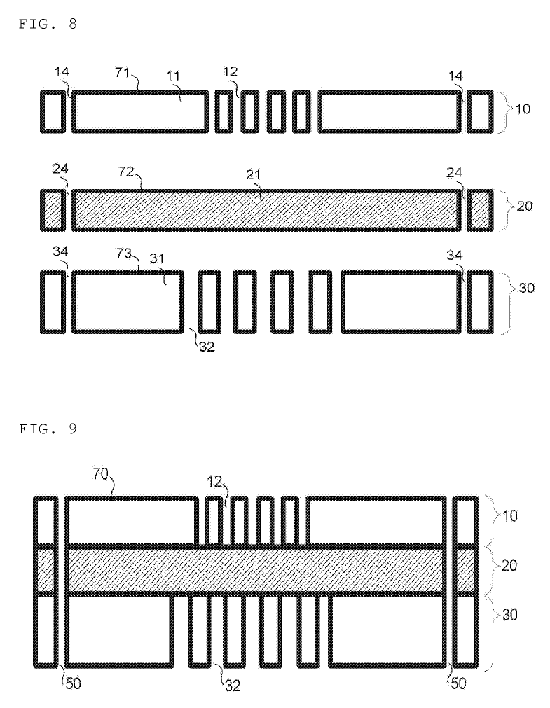

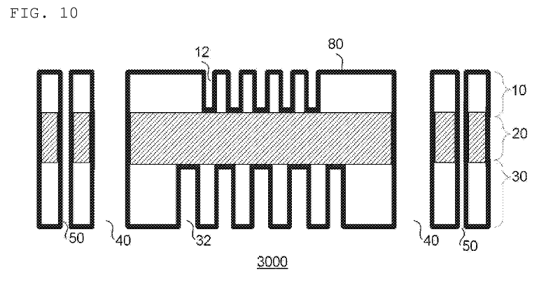

FIGS. 5 to 7 show a case where the metal unit of the present invention is the metal rod 60, and FIGS. 8 and 9 show a case where the metal unit of the present invention is metal deposition layers 71, 72, 73 and 70.

The constitution of the cathode membrane 10, the separation membrane 20 and the anode membrane 30 of FIG. 8 is similar to the constitution thereof based on FIG. 5. However, the constitution is characterized in that the penetration pores 13, 23 and 33 are not provided in the respective membranes 10, 20 and 30, and the metal deposition layers 71, 72 and 73 are provided on the surfaces of the photosensitive glasses 11, 21 and 31 that constitute the respective membranes 10, 20 and 30.

Preferably, the metal deposition layers are provided on the entire surface of the cathode membrane 10, the entire surface of the separation membrane 20, and the entire surface of the anode membrane 30.

The metal deposition layers 71, 72 and 73 are preferably at least one selected from the group consisting of silver, gold, platinum, nickel, chrome, titanium, and aluminum, and the deposition thereof may be performed using common E-beam deposition device, sputter, thermal/physical evaporator, etc.

Similar to the above-mentioned metal rod, the metal deposition layers 71, 72 and 73 provide the intermembrane current moving path, the intercell current moving path of the fuel cell, and the current moving path between the cell of the fuel cell and the external circuit and has an advantage that electrons generated from the assembly-electrode assembly can be collected effectively.

In view of the surface resistance, the durability and the maintenance of the ultra-fine structure provided in the bipolar plate according to the characteristics of the present invention, the thickness of the metal deposition layers 71, 72 and 73 is preferably 10 nm to 100 μm.

Even when the metal unit is the metal deposition layers as shown in FIG. 8, a basic unit structure of FIG. 9 is preferably formed by the intermembrane 10, 20 and 30 thermal coupling.

FIG. 10 shows a case where a metal deposition layer 80 is provided on the surface of the basic unit 1000 described referring to FIG. 6. The metal deposition layer 80 is preferably at least one selected from the group consisting of silver, gold, platinum, nickel, chrome, titanium and aluminum. In view of the surface resistance, the durability and the maintenance of the ultra-fine structure provided in the bipolar plate according to the characteristics of the present invention, the thickness of the metal deposition layer provided on the basic unit 1000 is preferably 10 nm to 100 μm. At this time, the metal deposition layer 80 is preferably provided on the entire surface of the basic unit 1000.

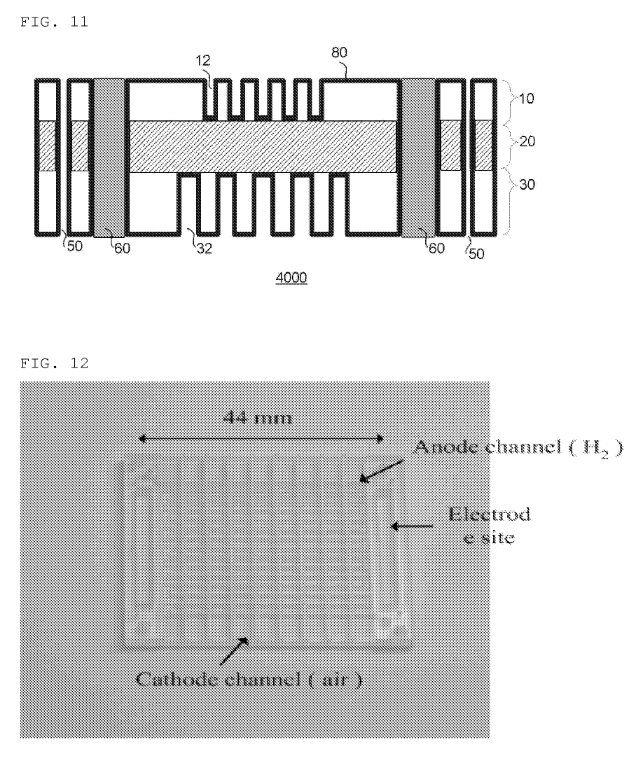

FIG. 11 is a cross-sectional view of a preferred bipolar plate 4000 of the present invention. The bipolar plate 4000, which includes the metal deposition layer 80 provided on the surface of the basic unit 1000 and the metal rod 60, effectively collects electrons generated from the membrane-electrode assembly simultaneously with stably providing the intermembrane current moving path of the cathode membrane 10, the separation membrane 20 and the anode membrane 30 and the intercell current moving path of the fuel cell that constitutes the stack, and provides the electrical connection with the external circuit.

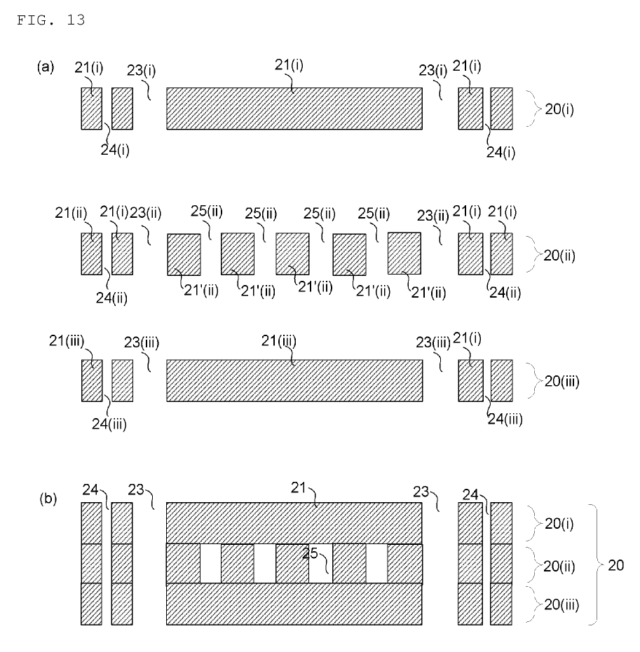

FIG. 12 is an optical photograph of the basic unit 1000 that is one of the constituents of the bipolar plate of the present invention. The metal rod of the present invention is provided on penetration pores (electrode site in FIG. 12) provided on both left and right sides of the basic unit in FIG. 12.

FIG. 13 is another example of the separation membrane 20 among the constituents of the bipolar plate in accordance with the embodiment of the present invention, more specifically, another example of the separation membrane 20 that separates the fuel flow channel 32 provided on the anode membrane 30 from the air flow channel 12 provided on the cathode membrane 10 simultaneously with being provided with a cooling fluid channel 25.

Referring to FIG. 13(a), the separation membrane 20 includes a upper separation membrane 20(i) that seals one side of the fuel flow channel 32 provided on the anode membrane 30; a cooling channel membrane 20(ii) formed with barrier ribs 21′(ii) of a cooling fluid channel; and a lower separation membrane 20(iii) that seals one side of the air flow channel 12 provided on the cathode membrane 10, wherein preferably, the upper separation membrane 20(i), the cooling channel membrane 20(ii), and the lower separation membrane 20(iii) are sequentially stacked to be thermally coupled, as shown in FIG. 13(b).

The upper separation membrane 20(i) physically separates the fuel flow channel 32 from the cooling fluid channel 25, and the lower separation membrane 20(iii) physically separates the air flow channel 12 from the cooling fluid channel 25.

The separation membrane 20(i), the cooling channel membrane 20(ii), and the lower separation membrane 20(iii) are manufactured by the exposure of ultraviolet rays, the annealing selectively performed, and the partial etching of the exposed region, using the mask described based on FIG. 4, and thereby, having the advantages that the cooling fluid channel provided on the separation membrane 20 can also have a very fine barrier rib structure, very fine channels can be provided, and highly complicated shaped channels can also be provided.

While the present invention has been described with respect to the specific embodiments, it will be apparent to those skilled in the art that various changes and modifications may be made without departing from the spirit and scope of the invention as defined in the following claims.

1. A bipolar plate for a fuel cell, including:
a non-conductive anode membrane on which a fuel flow channel is formed;
a non-conductive cathode membrane on which an air flow channel is formed;
a non-conductive separation membrane that is provided between the anode membrane and the cathode membrane to separate them from each other so that the fuel and the air are not mixed; and
a metal unit that provides a current moving path allowing charge to be moved from the anode membrane to the cathode membrane via the separation membrane when the anode membrane, the separation membrane and the cathode membrane are stacked sequentially.

2. The bipolar plate of claim 1, wherein the anode membrane, the cathode membrane and the separation membrane are glass, respectively.

3. The bipolar plate of claim 2, wherein the anode membrane, the cathode membrane and the separation membrane are photosensitive glass, respectively.

4. The bipolar plate of claim 2, wherein the anode membrane, the cathode membrane and the separation membrane are photosensitive recrystallization glass, respectively.

5. The bipolar plate of claim 3, wherein the anode membrane, the cathode membrane and the separation membrane are photosensitive glass that is photosensitized by ultraviolet rays.

6. The bipolar plate of claim 2, wherein the metal unit is at least one metal rod that penetrates through the anode membrane, the cathode membrane and the separation membrane.

7. The bipolar plate of claim 2, wherein the metal unit is a metal deposition layer deposited on the respective surfaces of the anode membrane, the cathode membrane and the separation membrane.

8. The bipolar plate of claim 2, wherein the bipolar plate includes a basic unit where the anode membrane, the cathode membrane and the separation membrane are stacked sequentially and thermally coupled, and the metal unit.

9. The bipolar plate of claim 8, wherein the bipolar plate further includes a metal deposition layer provided on the surface of the basic unit.

10. The bipolar plate of claim 6, , wherein the metal is at least one selected from the group consisting of silver, gold, platinum, nickel, chrome, titanium and aluminum.

11. The bipolar plate of claim 5, wherein a channel of the anode membrane or the cathode membrane is formed by removing a region on which light is selectively exposed by a mask pattern from a photosensitive glass plate that is raw material of the anode membrane or the cathode membrane.

12. The bipolar plate of claim 11, wherein the channel is a channel that is penetrated in the thickness direction of the photosensitive glass plate.

13. The bipolar plate of claim 11, wherein the channel is formed by recrystallizing the region on which the light is exposed through annealing and then etching the recrystallized region.

14. The bipolar plate of claim 13, wherein the separation membrane is provided with a cooling fluid channel.
